(19) United States
(12) Patent Application Publication
(10) Pub. No.: US 2020/0290201 A1
(43) Pub. Date: Sep. 17, 2020

(54) LEAST SQUARE-BASED MECHANICAL ARM CONTROL METHOD FOR ROBOT EXPERIMENTAL TEACHING

(71) Applicant: Wuyi University, Jiangmen (CN)

(72) Inventors: Tianlei WANG, Jiangmen (CN); Zhu WANG, Jiangmen (CN); Tianqing WANG, Jiangmen (CN); Xin ZHANG, Jiangmen (CN); Bing LUO, Jiangmen (CN); Ye LI, Jiangmen (CN); Yuqing WANG, Jiangmen (CN); Jingling ZHANG, Jiangmen (CN); Xiaoxi HAO, Jiangmen (CN)

(21) Appl. No.: 16/753,007

(22) PCT Filed: Mar. 22, 2019
(86) PCT No.: PCT/CN2019/079255

§ 371 Date: Apr. 2, 2020

(30) Foreign Application Priority Data
Jul. 9, 2018 (CN) 201810745022.9

(51) Int. Cl. B25J 9/16; B25J 15/00; G06T 1/00; G06T 7/246

(52) U.S. Cl. CPC B25J 9/1646; B25J 9/1697; B25J 15/0028; G06T 2207/20084; G06T 1/0014; G06T 7/246; G06T 2207/20081; B25J 9/1664

(57) ABSTRACT

Disclosed is a least square-based mechanical arm control method for robot experimental teaching, which includes: acquiring an image of a target object, and calculating position coordinates of the target object by using the image of the target object; setting a pickup distance, selecting a plurality of first sample points and second sample points according to a position target, and controlling, by using a swing steering engine, a claw to sequentially move along a first trajectory and a second trajectory; reading a duty ratio S of PWM signals in the swing steering engine, and calculating a value of Dᵢ=S/P; fitting xᵢ based on a least square method to obtain a fitted equation; adjusting the pickup distance, and correspondingly setting the duty ratio of PWM signals in the swing steering engine according to the fitted data and controlling the claw to sequentially move along the first trajectory and the second trajectory.

### CROSS REFERENCE TO RELATED APPLICATIONS

This application is a national stage application under 35 U.S.C. 371 of PCT Application No. PCT/CN2019/079255, filed on 22 Mar. 2019, which PCT application claimed the benefit of Chinese Patent Application No. 2018107450229, filed on 9 Jul. 2018, the entire disclosure of each of which are hereby incorporated herein by reference.

### TECHNICAL FIELD

The present disclosure relates to mechanical arms for robots, and in particular, to a least square-based mechanical arm control method for robot experimental teaching.

### BACKGROUND

Currently, image identification and positioning of robots is generally as follows: the distance from a target object to the robot is calculated and then transmitted to a mechanical arm control system, and the mechanical arm is controlled to grip the target object by a steering engine. A common mechanical arm is a two-connecting-rod mechanism, and each connecting rod is driven by a separate steering engine. During the movement process, since a claw is required to vertically descend from a certain height to a predetermined target position, it is expected to move the claw along a vertical downward trajectory. However, the two-connecting-rod mechanism driven by steering engines is difficult to realize accurate positioning.

Specifically, the mechanical arm (i.e., two-connecting-rod mechanism) generally includes a large arm, a small arm and a claw. If it is assumed that the coordinates of the gripping position of the claw is P(y, z), the following relation can be obtained as:

$$\{ \begin{matrix}{y}_{p} = {l}_{1} cos {θ}_{1} + {l}_{2} cos ( {θ}_{1} + {θ}_{2} ) \\ {z}_{p} = {l}_{1} sin {θ}_{1} + {l}_{2} sin ( {θ}_{1} + {θ}_{2} )\end{matrix} ,$$

where θ₁ is the included angle between the large arm and a horizontal plane after the large arm is controlled to rotate by the steering engine, θ₂ is the included angle between the small arm and an extension line of the large arm, and I₁ and I₂ are constants. An inverse function of the relation is obtained as:

$$\{ \begin{matrix}{θ}_{1} = arccos [ \frac{{y}_{p}^{2} + {z}_{p}^{2} + {l}_{1}^{2} - {l}_{2}^{2}}{2 {l}_{1} {x}_{p}} cos {θ}_{p} ] + a r c t g \frac{{z}_{p}}{{y}_{p}} \\ {θ}_{2} = arccos [ \frac{{y}_{p}^{2} + {z}_{p}^{2} + {l}_{2}^{2} - {l}_{1}^{2}}{2 {l}_{2} {x}_{p}} c o s {θ}_{p} ] + a r c t g \frac{{z}_{p}}{{y}_{p}} - {θ}_{1}\end{matrix} .$$

It can be seen from the above formula that the evaluation of θ₁ and θ₂ is relatively complicated during implementation, which has a great influence on gripping and presents a nonlinear coupling relationship. This causes some difficulties to the realization of trajectories, particularly the calibration of trajectories to the target position.

### SUMMARY

In order to address the above problems, an objective of the present disclosure is to provide a least square-based mechanical arm control method for robot experimental teaching, which can simplify the calibration step, improve the pickup efficiency of mechanical arms and be convenient to use in robot experiment teaching.

In order to make up the deficiencies of the prior art, technical solutions adopted by the present disclosure are as follows.

A least square-based mechanical arm control method for robot experimental teaching is provided, the method includes:

acquiring an image of a target object, and calculating the position coordinates of the target object by using the image of the target object;

setting a pickup distance, i.e., a distance xᵢ from a center of rotation of a mechanical arm to a claw, selecting a plurality of first sample points and second sample points according to a position target, and controlling, by a swing steering engine, the claw to sequentially move along a first trajectory and a second trajectory, wherein the plurality of first sample points/second sample points are horizontally arranged at equal intervals, and each of the second sample points is located directly below a corresponding first sample point; and a movement trajectory from a starting position to each of the first sample points is the first trajectory and a movement trajectory from each of the first sample points to a corresponding second sample point is the second trajectory;

reading a duty ratio S of PWM signals in the swing steering engine during the two movement trajectories, and calculating a value of Dᵢ=S/P, where Dᵢ is fitted data and P is the resolution of the swing steering engine;

fitting xᵢ based on a least square method to obtain a fitted equation:

Dᵢ(xᵢ)=c₀+c₁xᵢ+c₂ xᵢ², where C₀, C₁ and C₂ are equation parameters;

adjusting the pickup distance, obtaining the fitted data according to the fitted equation, correspondingly setting the duty ratio of the PWM signals in the swing steering engine, and controlling, by the swing steering engine, the claw to sequentially move along the first trajectory and the second trajectory so that the claw reaches the position of the target object; and

controlling the claw to close to grip the target object and lift the target object up.

Further, the image of the target object is acquired by a camera or a high-speed camera.

Further, calculating position coordinates of the target object by using the image of the target object includes:

transmitting the image of the target object into a computer through a wireless router; and

analyzing and calculating position coordinates of the target object by the computer.

Further, analyzing and calculating position coordinates of the target object by the computer includes:

sequentially performing Gaussian filtering, channel-differential binarization segmentation and morphological processing on the image of the target object to obtain a converted image; and

identifying features of the converted image by a BP neural network algorithm to obtain position coordinates of the target object.

Further, there are 10 selected first sample points and 10 selected second sample points.

Further, the selecting a plurality of first sample points and second sample points according to a position target includes:

calculating a horizontal gripping range of the target object according to the position target;

selecting a plurality of first sample points arranged horizontally at a height above the horizontal gripping range; and

selecting corresponding second sample points directly below the first sample points in the horizontal gripping range.

Further, the pickup distance is adjusted by controlling the mechanical arm to rotate to the front of the target object by a rotary steering engine.

The present disclosure has the following beneficial effects: An image is acquired and processed to obtain position coordinates of a target object, and corresponding sample points are selected for trajectory testing, that is, curve fitting is performed on the relationship between a duty ratio and a pickup distance by a least square method. After this process, a fitted equation with a single variable is finally obtained. Therefore, fitted data and thus the duty ratio can be determined by determining a new pickup distance. Subsequently, a claw can be delivered to the position of the target object to realize gripping by only adjusting the duty ratio. Compared with the conventional technologies, geometrical parameters of two connecting rods (particularly the change in angle between two rods caused by the actual position) are not taken into consideration, so that the calibration is simpler and more convenient. Therefore, in the present disclosure, fitting is performed by the least square method, which greatly simplifies the step of calibrating trajectories, and is beneficial to improving the pickup efficiency of mechanical arms and is convenient for robot experiment teaching.

### BRIEF DESCRIPTION OF THE DRAWINGS

The embodiments of the present disclosure will be described below in detail by preferred embodiments of the present disclosure with reference to the accompanying drawings.

FIG. 1 is a flowchart of steps of the present disclosure; and

FIG. 2 is a schematic view of the present disclosure.

### DETAILED DESCRIPTION

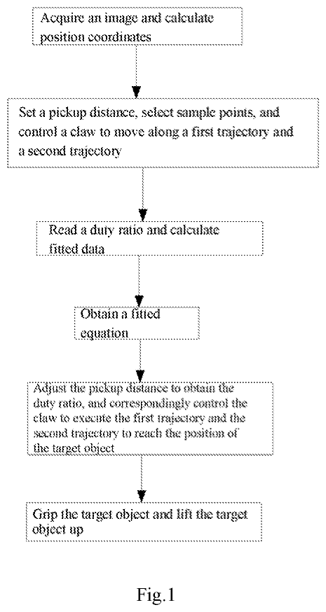

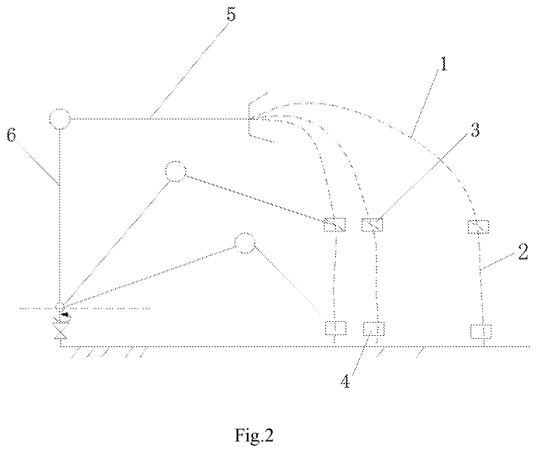

With reference to FIGS. 1 and 2, the present disclosure provides a least square-based mechanical arm control method for robot experimental teaching, the method includes:

acquiring an image of a target object, and calculating position coordinates of the target object by using the image of the target object;

setting a pickup distance, i.e., a distance xᵢ from a center of rotation of a mechanical arm to a claw, selecting a plurality of first sample points 3 and second sample points 4 according to a position target, and controlling, by a swing steering engine, the claw to sequentially move along a first trajectory 1 and a second trajectory 2, wherein the plurality of first sample points 3/second sample points 4 are horizontally arranged at equal intervals, and each of the second sample points 4 is located directly below a corresponding first sample point 3; and a movement trajectory from a starting position to each of the first sample points is the first trajectory 1 and, a movement trajectory from each of the first sample points to a corresponding second sample point 4 is the second trajectory 2;

reading a duty ratio S of PWM signals in the swing steering engine during the two movement trajectories, and calculating a value of Dᵢ=S/P, where Dᵢ is fitted data and P is the resolution of the swing steering engine;

fitting xᵢ based on a least square method to obtain a fitted equation:

Dᵢ(xᵢ)=c₀+c₁xᵢ+c₂xᵢ² where C₀, C₁ and C₂ are equation parameters;

adjusting the pickup distance, obtaining the fitted data according to the fitted equation, correspondingly setting the duty ratio of the PWM signals in the swing steering engine, and controlling, by the swing steering engine, the claw to sequentially move along the first trajectory 1 and the second trajectory 2 so that the claw reaches the position of the target object; and

controlling the claw to close to grip the target object and lift the target object up.

Specifically, an image is acquired and processed to obtain position coordinates of a target object, and corresponding sample points are selected for trajectory testing, that is, curve fitting is performed on the relationship between a duty ratio and a pickup distance by a least square method. After this process, a fitted equation with a single variable is finally obtained. Therefore, fitted data and thus the duty ratio can be determined by determining a new pickup distance. Subsequently, a claw can be delivered to the position of the target object to realize gripping by only adjusting the duty ratio. Compared with the conventional technologies, geometrical parameters of two connecting rods (particularly the change in angle between two rods caused by the actual position) are not taken into consideration, so that the calibration is simpler and more convenient. Therefore, in the present disclosure, fitting is performed by the least square method, which greatly simplifies the step of calibrating trajectories, and is beneficial to improving the pickup efficiency of mechanical arms and is convenient for robot experiment teaching.

Further, the image of the target object is acquired by a camera or a high-speed camera.

Further, the calculating position coordinates of the target object by using the image of the target object includes:

transmitting the image of the target object into a computer through a wireless router; and

analyzing and calculating position coordinates of the target object by the computer.

Further, the analyzing and calculating position coordinates of the target object by the computer includes:

sequentially performing Gaussian filtering, channel-differential binarization segmentation and morphological processing on the image of the target object to obtain a converted image; and

identifying features of the converted image by a BP neural network algorithm to obtain position coordinates of the target object.

Specifically, the principles of the Gaussian filtering, channel-differential binarization segmentation and morphological processing are basically known to those skilled in the art, and the BP neural network algorithm is also an existing means. Therefore, the specific process will not be repeated here.

Further, there are 10 selected first sample points 3 and 10 selected second sample points 4.

Further, the selecting a plurality of first sample points 3 and second sample points 4 according to a position target includes:

calculating a horizontal gripping range of the target object according to the position target;

selecting a plurality of first sample points 3 arranged horizontally at a height above the horizontal gripping range; and

selecting corresponding second sample points 4 directly below the first sample points 3 in the horizontal gripping range.

Specifically, although the calculated position target is obtained based on the processed image, there is still a certain error. Therefore, there should not be too many limitations on the gripping position, and the horizontal gripping range is thus set. Generally, a position point is selected on each of the left and right sides of the same horizontal plane of the position target, and two position points are used as two endpoints of the horizontal gripping range.

Further, the pickup distance is adjusted by controlling the mechanical arm to rotate to the front of the target object (preferably to the right front of the target object) by a rotary steering engine. In this way, it is convenient to adjust the pickup distance, and the path of moving the mechanical arm for adjustment is simpler.

Further, the claw is controlled by a gripping steering engine to close to grip the target object and lift the target object up.

Specifically, in this embodiment, the mechanical arm is not limited, and the gripping operation may be performed based on a common mechanical arm of a robot.

With reference to FIG. 2, the common mechanical arm includes a base, a manipulator and corresponding steering engines. The manipulator includes a claw, and the steering engines include a rotary steering engine for controlling the manipulator to rotate horizontally on the base, a gripping steering engine for controlling the claw to open and close, a swing steering engine for controlling the manipulator to swing, and corresponding two-connecting-rod mechanisms. The manipulator further includes a large arm 6 and a small arm 5. The swing steering engine includes a second steering engine for controlling the large arm 6 and a third steering engine for controlling the small arm 5.

Therefore, one trajectory is actually completed by the actions of the large arm 6 and the small arm 5. During testing, the duty ratios of the second steering engine and the third steering engine may be acquired, and least-square segmented curve fitting is performed according to the respective duty ratios and the pickup distance to obtain a fitted control curve, that is, a fitted equation. In the actual gripping process, the duty ratio is calculated according to the corresponding fitted equation to realize the control of the large arm 6 and the small arm 5.

It can be known that the principle is the same as that of controlling a single swing steering engine. Thus, it can be inferred that, no manner how many components need to be controlled, it can be realized by the method of the present disclosure as long as the corresponding steering engine is fitted.

Preferably, in this embodiment, the swing steering engine, the rotary steering engine and the gripping steering engine are all driven by a PCA9685 module and have an inherent resolution of 4069, i.e., Dᵢ=S/4069.

Although the preferred embodiments and basic principles of the present disclosure have been described in detail above, the present disclosure is not limited to the embodiments. It should be understood by those skilled in the art that various equivalent variations and substitutions may made without departing from the spirit of the present disclosure, and these variations and substitutions shall fall into the scope of the present disclosure sought to protect.

1. A least square-based mechanical arm control method for robot experimental teaching, comprising:
acquiring an image of a target object, and calculating position coordinates of the target object by using the image of the target object;
setting a pickup distance, i.e., a distance xᵢ from a center of rotation of a mechanical arm to a claw;
selecting a plurality of first sample points and second sample points according to a position target;
controlling, by a swing steering engine, the claw to sequentially move along a first trajectory and a second trajectory, wherein the plurality of first sample points/second sample points are horizontally arranged at equal intervals, and each of the second sample points is located directly below a corresponding first sample point; and a movement trajectory from a starting position to each of the first sample points is the first trajectory and a movement trajectory from each of the first sample points to a corresponding second sample point is the second trajectory;
reading a duty ratio S of PWM signals in the swing steering engine during the two movement trajectories, and calculating a value of Dᵢ=S/P, where Dᵢ is fitted data and P is a resolution of the swing steering engine;
fitting xᵢ based on a least square method to obtain a fitted equation:
Dᵢ(xᵢ)=c₀xᵢ+c₂xᵢ², where C₀, C₁ and C₂ are equation parameters;
adjusting the pickup distance, obtaining the fitted data according to the fitted equation, correspondingly setting the duty ratio of the PWM signals in the swing steering engine, and controlling, by the swing steering engine, the claw to sequentially move along the first trajectory and the second trajectory so that the claw reaches the position of the target object; and
controlling the claw to close to grip the target object and lift the target object up.

2. The least square-based mechanical arm control method for robot experimental teaching of claim 1, wherein the image of the target object is acquired by a camera or a high-speed camera.

3. The least square-based mechanical arm control method for robot experimental teaching of claim 1, wherein calculating the position coordinates of the target object by using the image of the target object comprises:
transmitting the image of the target object to a computer through a wireless router; and
analyzing and calculating the position coordinates of the target object by the computer.

4. The least square-based mechanical arm control method for robot experimental teaching of claim 3, wherein analyzing and calculating the position coordinates of the target object by the computer comprises:
sequentially performing Gaussian filtering, channel-differential binarization segmentation and morphological processing on the image of the target object to obtain a converted image; and
identifying features of the converted image by a BP neural network algorithm to obtain the position coordinates of the target object.

5. The least square-based mechanical arm control method for robot experimental teaching of claim 1, wherein there are 10 selected first sample points and 10 selected second sample points.

6. The least square-based mechanical arm control method for robot experimental teaching of claim 1, wherein selecting a plurality of first sample points and second sample points according to a position target comprises:
calculating a horizontal gripping range of the target object according to the position target;
selecting a plurality of first sample points arranged horizontally at a height above the horizontal gripping range; and
selecting corresponding second sample points directly below the first sample points in the horizontal gripping range.

7. The least square-based mechanical arm control method for robot experimental teaching of claim 1, wherein the pickup distance is adjusted by controlling the mechanical arm to rotate to the front of the target object by a rotary steering engine.

8. The least square-based mechanical arm control method for robot experimental teaching of claim 2, wherein the pickup distance is adjusted by controlling the mechanical arm to rotate to the front of the target object by a rotary steering engine.

9. The least square-based mechanical arm control method for robot experimental teaching of claim 3, wherein the pickup distance is adjusted by controlling the mechanical arm to rotate to the front of the target object by a rotary steering engine.

10. The least square-based mechanical arm control method for robot experimental teaching of claim 4, wherein the pickup distance is adjusted by controlling the mechanical arm to rotate to the front of the target object by a rotary steering engine.

11. The least square-based mechanical arm control method for robot experimental teaching of claim 5, wherein the pickup distance is adjusted by controlling the mechanical arm to rotate to the front of the target object by a rotary steering engine.

12. The least square-based mechanical arm control method for robot experimental teaching of claim 6, wherein the pickup distance is adjusted by controlling the mechanical arm to rotate to the front of the target object by a rotary steering engine.
